(19) United States
(12) Patent Application Publication
(10) Pub. No.: US 2011/0142676 A1
(43) Pub. Date: Jun. 16, 2011

(54) ROTOR BLADE ASSEMBLY HAVING AN AUXILIARY BLADE

(75) Inventors: Omer Mohammed, Bangalore (IN); Jonathan Glenn Luedke, Simpsonville, SC (US); Stefan Herr, Greenville, SC (US)

(73) Assignee: GENERAL ELECTRIC COMPANY, Schenectady, NY (US)

(21) Appl. No.: 12/946,963

(22) Filed: Nov. 16, 2010

(51) Int. Cl. F03B 3/12

(52) U.S. Cl. 416/241 R

(57) ABSTRACT

A rotor blade assembly for a wind turbine is disclosed. The rotor blade assembly may generally include a primary rotor blade and an auxiliary rotor blade disposed on a suction side of the primary rotor blade. The auxiliary blade may generally include an upstream edge and a downstream edge, with the upstream edge being positioned downstream of a leading edge of the primary rotor blade.

### FIELD OF THE INVENTION

The present subject matter relates generally to rotor blades for a wind turbine and, more particularly, to a rotor blade assembly having one or more auxiliary blades configured to prevent or delay flow separation occurring on the primary rotor blade.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades are the primary elements for converting wind energy into electrical energy. The blades typically have the cross-sectional profile of an airfoil such that, during operation, air flows over the blade producing a pressure difference between the sides. Consequently, a lift force, which is directed from the pressure side towards the suction side, acts on the blade. The lift force generates torque on the main rotor shaft, which is geared to a generator for producing electricity.

As air flows over the leading edge of a conventional rotor blade, the airflow typically sticks or remains attached to the rotor blade along a portion of its suction side, thereby generating the lift force which acts on the blade. However, as the air flows downstream toward the trailing edge of the blade, a point is reached at which the flow of air detaches or separates from the surface of the rotor blade, becoming more turbulent. This flow separation typically causes a reduction in the lift force generated by the blade and also leads to an increase in drag force. As such, the overall aerodynamic efficiency of the rotor blade is reduced.

Accordingly, a rotor blade assembly that prevents or, at the very least, delays flow separation occurring on the rotor blade would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter discloses a rotor blade assembly for a wind turbine. The rotor blade assembly may generally include a primary rotor blade and an auxiliary blade disposed on a suction side of the primary rotor blade. The auxiliary blade may generally include an upstream edge and a downstream edge, with the upstream edge being positioned downstream of a leading edge of the primary rotor blade.

In another aspect, the present subject matter discloses a rotor blade assembly for a wind turbine. The rotor blade assembly may generally include a primary rotor blade and an auxiliary blade disposed on a suction side of the primary rotor blade. The rotor blade assembly may also include a support member configured to couple the auxiliary blade to the primary rotor blade. The auxiliary blade may generally include an upstream edge and a downstream edge, with the upstream edge being position between a leading edge of the primary rotor blade and an airflow separation point of the primary rotor blade. Additionally, the auxiliary blade may be configured such that a converging passage is defined between the auxiliary blade and the suction side of the primary rotor blade.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a conventional wind turbine;

FIG. 2 illustrates a cross-sectional view of a conventional rotor blade, particularly illustrating the flow separation that typically occurs as air flows over the rotor blade;

FIG. 3 illustrates a perspective view of an embodiment of a rotor blade assembly in accordance with aspects of the present subject matter;

FIG. 4 illustrates a perspective view of a portion of the embodiment of the rotor blade assembly illustrated in FIG. 3;

FIG. 5 illustrates a cross-sectional view of the embodiment of the rotor blade assembly illustrated in FIGS. 3 and 4.

FIG. 6 illustrates a partial perspective view of another embodiment of a rotor blade assembly in accordance with aspects of the present subject matter; and

FIG. 7 illustrates a partial perspective view of a further embodiment of a rotor blade assembly in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

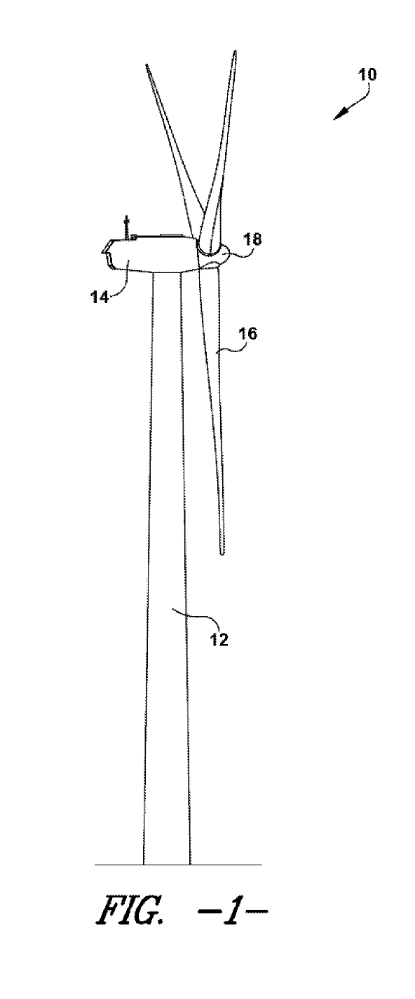

Referring now to the drawings, FIG. 1 illustrates perspective view of a wind turbine 10 of conventional construction. The wind turbine 10 includes a tower 12 with a nacelle 14 mounted thereon. A plurality of rotor blades 16 are mounted to a rotor hub 18, which is, in turn, connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration.

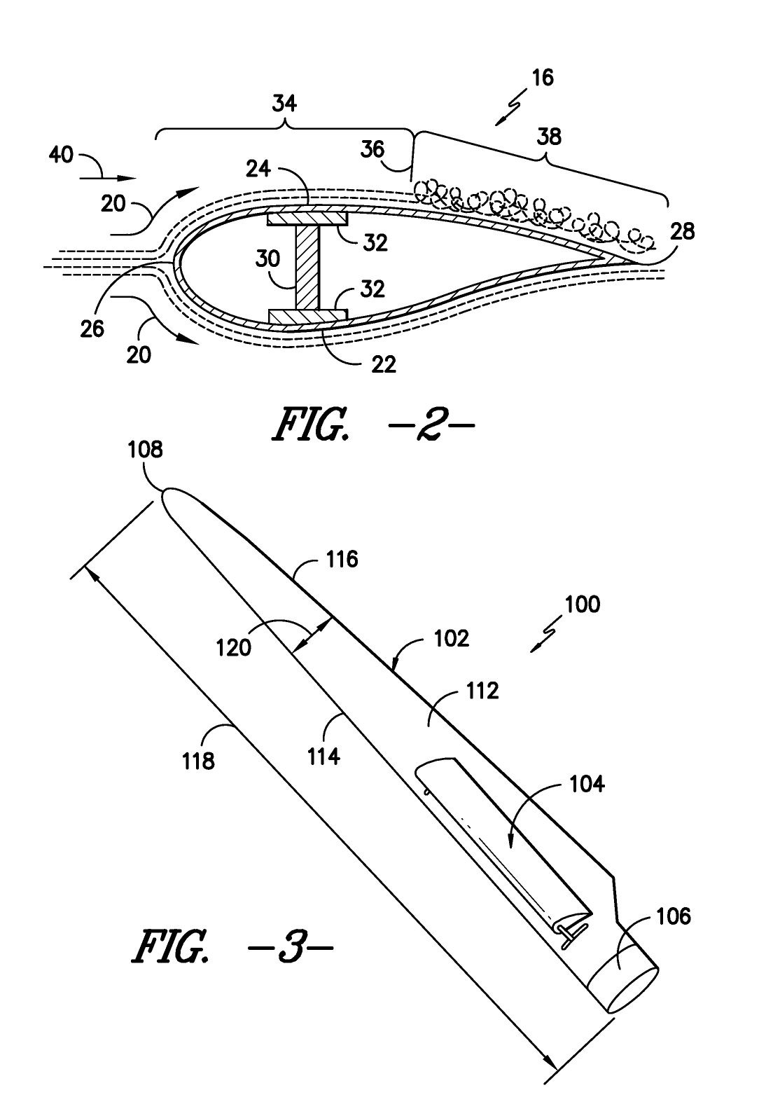

Referring now to FIG. 2, there is illustrated a cross-sectional view of a rotor blade 16 of conventional construction, particularly illustrating the flow separation that typically occurs as air 20 flows over the rotor blade 16. As shown, the rotor blade 16 generally includes a pressure side 22 and a suction side 24 extending between leading and trailing edges 26, 28. The rotor blade 16 may also include internal structural components, such as one or more shear webs 30 disposed between corresponding spar caps 32. In general, during operation of a wind turbine 10, the air 20 flowing over the leading edge 26 of the rotor blade 16 is initially in an “attached-flow” region 34 of the rotor blade 16, wherein the air 20 sticks to and/or flows directly adjacent to the outer surface of the suction side 24 of the rotor blade 16. A majority of the lift force acting on the rotor blade 16 is generated in this attached-flow region 34. However, as the air 20 flows in the direction of the trailing edge 28 of the blade 16, a separation point 36 is reached at which the flow detaches or separates from the blade 16. At such separation point 36, the flow of air 20 transitions into a “separated-flow” region 38 wherein the flow is more turbulent, thereby causing a reduction in the lift force generated by the rotor blade 16 in this region. Additionally, the separated-flow region 38 also leads to an increase in drag force, mainly due to a pressure difference between the upstream attached-flow region 34 and the downstream separated-flow region 38. Accordingly, the flow separation occurring downstream of the separation point 36 generally results in a reduction of the aerodynamic efficiency of the rotor blade 16 and, thus, a reduction in the conversion of the wind energy into rotational motion of the rotor blades 16. It should be appreciated by those of ordinary skill in the art that flow separation does not always occur over an entire rotor blade 16 and over all operation conditions. For example, during normal operating conditions, flow separation may primarily affect the root region of a rotor blade 16.

As is generally understood, the chordwise location of the separation point 36 on a rotor blade 16 may generally vary depending on numerous factors including, but not limited to, the incoming air flow characteristics (e.g., Reynolds number, wind speed, in-flow atmospheric turbulence, etc.) and the characteristics of the blade 16 (e.g., the airfoil design, blade chord and thickness, twist distribution, pitch angle, etc.). For example, as the angle of attack of the rotor blade 16 (i.e., the angle between the direction 40 of the wind and the chord line defined between the leading and trailing edges) is increased, the separation point 36 typically moves upstream on the rotor blade 16 in the direction of the leading edge 26.

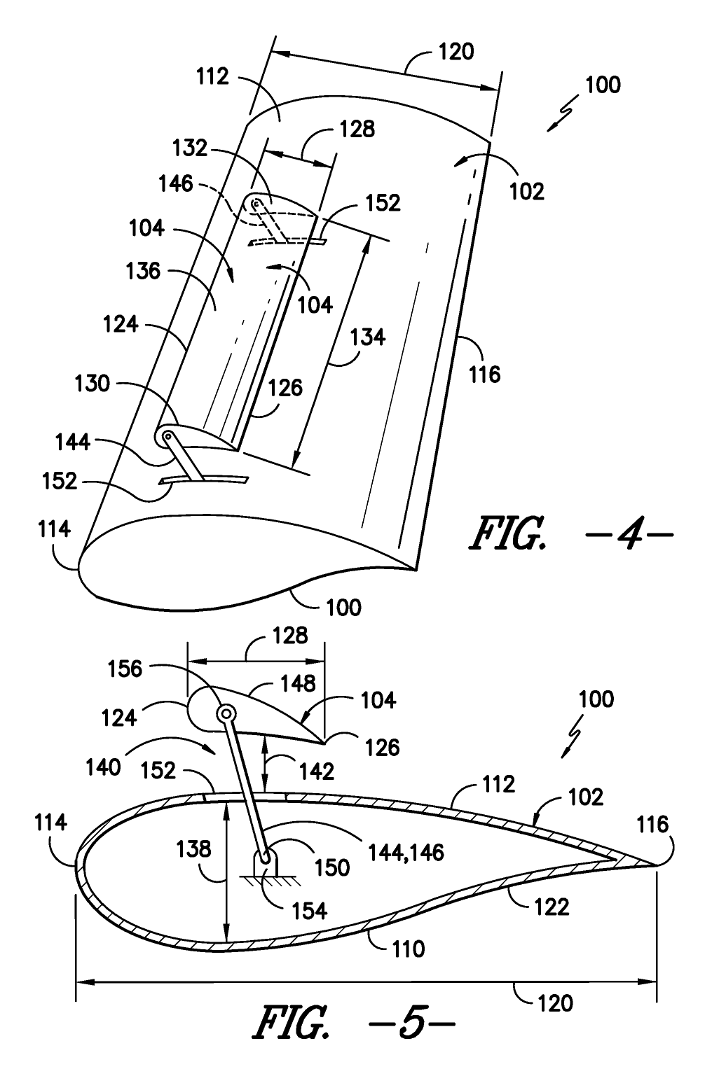

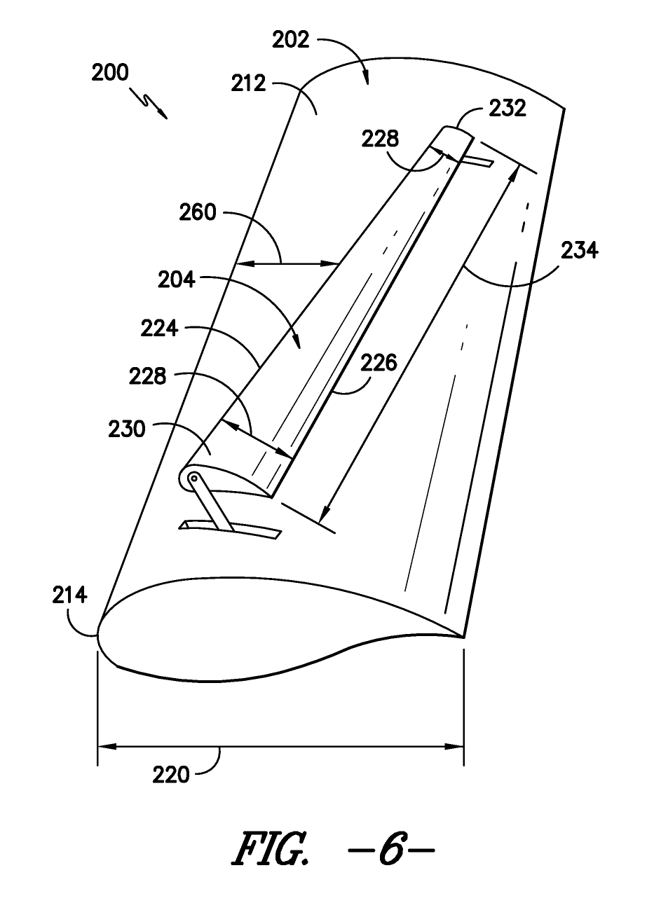

Referring now to FIGS. 3-5, there is illustrated one embodiment of a rotor blade assembly 100 for a wind turbine 10 (FIG. 1) designed to prevent or delay the occurrence of flow separation. In particular, FIG. 3 illustrates a perspective view of an embodiment of the disclosed rotor blade assembly 100. FIG. 4 illustrates a perspective view of a portion of the rotor blade assembly 100 shown in FIG. 3. Additionally, FIG. 5 illustrates a cross-sectional view of the rotor blade assembly 100 shown in FIGS. 3 and 4.

The rotor blade assembly 100 of the present subject matter generally includes a primary rotor blade 102 and at least one auxiliary blade 104 disposed on a suction side 112 of the primary rotor blade 102. The auxiliary blade 104 may generally be configured to prevent flow separation occurring on the suction side surface of the primary rotor blade 102 or, at the very least, delay the occurrence of flow separation (e.g., by causing the separation point 36 (FIG. 2) to be moved downstream in the direction of the trailing edge 116 of the primary rotor blade 102). Specifically, by disposing one or more suitable auxiliary blades 104 at particular location(s) on the suction side 112 of the primary rotor blade 102, the inventors of the present subject matter have discovered that the auxiliary blade(s) 104 add momentum to the free stream flowing adjacent to the suction side 112 and also cause the flow of air to be accelerated between the auxiliary blade 104 and the primary rotor blade 102. This added momentum and acceleration generally causes the flow of air stick to a larger area of the suction side surface, thereby increasing the attached-flow region 34 (FIG. 2) and preventing or delaying flow separation. As such, the lift force generated by the primary rotor blade 102 may be increased, resulting in enhanced aerodynamic efficiency/performance and increased energy conversion. Moreover, the auxiliary blade 104, itself, may generate lift forces leading to even further aerodynamic efficiency of the rotor blade assembly 100.

In general, the primary rotor blade 102 of the rotor blade assembly 100 may be configured similarly to any suitable wind turbine rotor blade known in the art. Thus, the primary rotor blade 102 may include a blade root 106 configured for mounting the primary rotor blade 102 to the hub 18 of the wind turbine 10 (FIG. 1) and a blade tip 108 disposed opposite the blade root 106. The primary rotor blade 102 may also include a pressure side 110 and a suction side 112 extending between a leading edge 114 and a trailing edge 116. Further, the primary rotor blade 102 may have a span 118 defining the total length between the blade root 106 and the blade tip 108 and a chord 120 defining the total length between the leading edge 114 and the trailing edge 116. As particularly shown in FIG. 3, the chord 120 may vary in length with respect to the span 118 as the rotor blade 102 extends from the blade root 106 to the blade tip 108.

The primary rotor blade 102 may also generally define any suitable aerodynamic profile or shape. In several embodiments, the primary rotor blade 102 may define an airfoil shaped cross-section. For example, the primary rotor blade 102 may be configured as a symmetrical airfoil or a cambered airfoil. Additionally, the primary rotor blade 102 may be aeroelastically tailored. Aeroelastic tailoring of the primary rotor blade 102 may entail bending the blade 102 in a generally chordwise direction and/or in a generally flapwise direction. The chordwise direction generally corresponds to a direction parallel to the chord 120 defined between the leading and trailing edges 114, 116 of the primary rotor blade 102. The flapwise direction generally corresponds to a direction perpendicular to the chordwise direction. Alternatively, the flapwise direction may be construed as the direction (or opposing direction) in which the aerodynamic lift force acts on the primary rotor blade 102. Aeroelastic tailoring of the primary rotor blade 102 may further entail twisting of the primary rotor blade 102, such as with respect to the generally chordwise or flapwise direction, if desired.

It should be appreciated that the primary rotor blade 102 may also have any suitable external structure. For example, as shown in FIG. 5, the primary rotor blade 102 may include an outer shell 122 defining the exterior surface of the blade 102 and, thus, forming the aerodynamic profile or shape of the rotor blade 102. The outer shell 122 may be a unitary shell, or may include a variety of shell components. Additionally, the main rotor blade 102 may include any suitable internal components, such as one or more shear webs 30 extending between corresponding spar caps 32 (FIG. 2). However, it should be understood that the internal and external structure and/or components of the primary rotor blade 102 need not be limited to the structure and/or components disclosed herein. Rather, the primary rotor blade 102 of the present disclosure may have any suitable internal and/or external configuration.

Referring particularly to FIGS. 4-5, the auxiliary blade 104 of the disclosed rotor blade assembly 100 may generally include an upstream edge 124, a downstream edge 126 and an auxiliary chord 128 defining the length between the upstream edge 124 and the downstream edge 126. In general, the auxiliary chord 128 may be equal to any suitable length. For example, in one embodiment, the auxiliary chord 128 may generally be equal to a length less than the maximum chord (i.e., the longest chord 120 between the leading edge 114 and the trailing edge 116) of the primary rotor blade 102. However, in a particular embodiment of the present subject matter, the auxiliary chord 128 may be equal to a length ranging from 0% to about 50% of the maximum chord of the primary rotor blade 102, such as from about 5% to about 35% of the maximum chord or from about 10% to about 25% of the maximum chord 120 and all other subranges therebetween. The auxiliary blade 102 may also include a root end 130, a tip end 132 and an auxiliary span 134 defining the length between the root end 130 and the tip end 132. The auxiliary span 134 may generally be equal to any suitable length. For instance, in one embodiment, the auxiliary span 134 may generally be equal to a length that is less than the span 118 of the primary rotor blade 102.

Additionally, as particularly shown in FIGS. 3 and 4, in one embodiment, the auxiliary blade 104 may generally define a suitable aerodynamic profile or shape. For example, the auxiliary blade 104 may be configured as a cambered or symmetrical airfoil. In such an embodiment, the upstream and downstream edges 124, 126 of the auxiliary blade 104 may generally correspond to leading and trailing edges, respectively, of the airfoil. Similar to that described above, the auxiliary blade 104 may also be aeroelastically tailored to enhance its aerodynamic performance. Alternatively, the auxiliary blade 104 may define a substantially non-aerodynamic profile or shape. For example, the auxiliary blade 104 may be configured as a relatively flat plate and may define a generally rectangular cross-section.

Similar to the primary rotor blade 102, the auxiliary blade 104 may also have any suitable external and internal structure and/or components. For example, the auxiliary blade may include an outer shell 136 defining the exterior surface of the auxiliary blade 104. The outer shell 136 may be a unitary shell, or may include a variety of shell components. Additionally, the auxiliary blade 104 may include internal structural components, such as one or more shear webs 30 extending between corresponding spar caps 32 (FIG. 2). However, it should be understood that the internal and external structure and/or components of the auxiliary blade 104 need not be limited to the structure and/or components disclosed herein. Rather, the auxiliary blade 104 of the present disclosure may have any suitable internal and/or external configuration.

As particularly shown in FIG. 4, the auxiliary blade 104 is disposed on the suction side 112 of the primary rotor blade 102 such that any flow separation occurring on the suction side 112 may be prevented or delayed. In general, the auxiliary blade 104 may be disposed, in the chordwise direction, at any suitable location along the chord 120 of the primary rotor blade 102. In one embodiment, the auxiliary blade 104 may be positioned such that no portion of the auxiliary blade 104 extends upstream of the leading edge 114 of the primary rotor blade 102. Thus, the upstream edge 124 of the auxiliary blade 104 may generally be aligned with or disposed downstream of the leading edge 114 of the primary rotor blade 102. In a particular embodiment of the present subject matter, the auxiliary blade 104 may be disposed along the chord 120 of the primary rotor blade 102 at the point of maximum thickness 138 of the primary rotor blade 102 (i.e., the maximum distance between the pressure side 110 and the suction side 112) for each respective chord 120.

Additionally, in another embodiment of the present subject matter, the auxiliary blade 104 may be disposed, in the chordwise direction, at a location between the leading edge 114 of the primary rotor blade 102 and the position at which the separation point 36 (FIG. 2) would be located in the absence of the auxiliary blade 104. For instance, the auxiliary blade 104 may be configured such that the upstream edge 124 or the downstream edge 126 of the auxiliary blade 104 is disposed upstream of the separation point 36. As indicated above, the location of the separation point 36 on a rotor blade may generally vary depending on numerous factors. However, for conventional rotor blades oriented at reasonable angles of attack, it has been found that the separation point 36 may generally be located a distance from the leading edge 114 equal to or less than approximately 50% of the chord of the rotor blade at a given point along the span 118. This may be particularly true for areas near the blade root 106 of the primary rotor blade 102. For example, assuming that the leading edge 114 of the primary rotor blade 102 defines a chord length of 0%, the separation point 36 may generally be located from about 0% to about 50% of the chord 120 at a given point along the span 118 of the primary rotor blade 102, such as from about 5% to about 40% of the chord 120 or from about 30% to about 35% of the chord 120 and all other subranges therebetween. It should be appreciated that, in alternative embodiments, the separation point may be located a distance from the leading edge 114 greater than approximately 50% of the chord 120 at a given point along the span 118 of the primary rotor blade 102. By positioning at least a portion of the auxiliary blade 104 upstream of the separation point 36, it has been found that the auxiliary blade 104 may effectively prevent or delay flow separation.

Further, the auxiliary blade 104 may also be spaced apart from the primary rotor blade 102 such that a gap or passage 140 is defined between the auxiliary blade 104 and the suction side 112 of the primary rotor blade 102. As shown in FIG. 4, in one embodiment, the auxiliary rotor blade 104 may be oriented relative to the suction side 112 of the primary rotor blade 102 such that the passage 140 converges between the upstream edge 124 and downstream edge 124 of the auxiliary blade 104. Such a converging passage 140 may generally help to guide the flow of air along the suction side 112 of the primary rotor blade 102 and may also permit the air to be accelerated as it flows through the passage 140, thereby enhancing the lift and drag performance of the primary rotor blade 102. However, it should be appreciated that the passage 140 defined between the auxiliary blade 104 and the primary rotor blade 102 need not be converging. For instance, in another embodiment, the auxiliary blade 104 may be oriented relative to the suction side 112 such that the height 142 of the passage 140 remains substantially constant from the upstream edge 124 to the downstream edge 126 of the auxiliary blade 104. Alternatively, the auxiliary blade 104 may be oriented relative to the suction side 112 of the primary rotor blade 102 such that the passage 140 diverges between the upstream and downstream edges 124, 126.

It should be appreciated that the passage 140 defined between the primary rotor blade 102 and the auxiliary blade 104 may generally be disposed at any suitable height 142 from the suction side 112 of the primary rotor blade 102. However, in several embodiments, the average height 142 of the passage 140 (i.e., the height at approximately the midpoint of the auxiliary chord 128) may range from about 0% to about 40% of the corresponding chord 120 of the primary rotor blade 102 at each spanwise location of the passage 140, such as from about 5% to about 30% of the corresponding chord 120 at each spanwise location or from about 10% to about 25% of the corresponding chord 120 at each spanwise location and all other subranges therebetween.

It should also be appreciated that the auxiliary blade 104 may generally be disposed at any suitable location and may extend any length in the spanwise direction (i.e., the longitudinal direction) between the blade root 106 and the blade tip 108 of the primary rotor blade 102. For example, in one embodiment, the auxiliary span 134 of the auxiliary blade 104 may extend substantially along the entire span 118 of the primary rotor blade 102. In other embodiments, the auxiliary span 134 of the auxiliary blade 104 may extend along only a portion of the span 118 of the primary rotor blade 102. For instance, it has been found that the flow separation occurring on the suction side 112 of the primary rotor blade 102 is particularly problematic in the area near the blade root 106. Thus, the auxiliary blade 104 may extend in a spanwise direction from generally adjacent the blade root 106 to any suitable distance from the blade root 106 at which flow separation may still be occurring. For example, in a particular embodiment, the auxiliary blade 104 may extend in a spanwise direction from generally adjacent the blade root 106 to a distance from the blade root 106 equal to or less than about 50% of the span 118 of the primary rotor blade 102, such as from about 0% to about 50% of the span 118 or from about 0% to about 30% of the span 118 or from about 10% to about 20% of the span 118 and all other subranges therebetween.

Referring still to FIGS. 3-5, the rotor blade assembly 100 of the present disclosure may further include one or more support members 144, 146 configured to mount and/or couple the auxiliary blade 104 to the primary rotor blade 102. For example, as shown in FIG. 4, a first support member 144 may be attached to the root end 130 of the auxiliary blade 104 and a second support member 146 may be attached to the tip end 132 of the auxiliary blade 104. However, it should be appreciated that, in general, any number of support members 144, 146 may be associated with and/or attached to any portion of the auxiliary blade 104 to permit the auxiliary blade 104 to be mounted and/or coupled to the primary rotor blade 102. It should also be appreciated that the support member(s) may generally comprise any suitable member configured to support the auxiliary blade 104 with respect to the primary rotor blade 102 such that a passage 140 is defined between the auxiliary blade 104 and the suction side 112 of the primary rotor blade 102. Thus, the support member(s) 144, 146 may comprise a support rod(s), a support frame(s) and/or any other suitable structural member.

In general, the support member(s) 144, 146 may be attached at a first end 148 to the auxiliary blade 104 and at a second end 150 to any internal and/or external component of the primary rotor blade 102. For example, the support member(s) 144, 146 may extend through an opening 152 defined in the outer shell 122 of the primary rotor blade 102 so that the second end 150 of the support member(s) 144, 146 may be attached to an internal component of the blade 102, such as the shear web 30, spar caps 32 (FIG. 2), or any other suitable internal component.

In one embodiment, the support member(s) 144, 146 may be configured to couple the auxiliary blade 104 to the primary rotor blade 102 such that the position and/or orientation of the auxiliary blade 104 is fixed relative to the primary rotor blade 102. Alternatively, the position and/or orientation of the auxiliary blade 104 may be adjustable to account for varying wind/operating conditions and/or controller conditions. For example, in several embodiments, the position of the auxiliary blade 104 may be adjustable in the chordwise direction and/or in any other direction relative to the suction side 112 of the primary rotor blade 102 (e.g., by adjusting the position of the auxiliary blade 104 relative to the primary rotor blade 102 such that the height 142 of the passage 140 is increased or decreased). Thus, as shown in FIG. 5, the second end 150 of the support member(s) 144, 146 may be attached to any suitable displacement device 154 configured to permit the position of the auxiliary blade 104 to be adjusted. The displacement device 154 may, in turn, be secured to an internal component of the rotor blade 102, such as the shear web 30, the spar caps 32 (FIG. 2) or any other suitable internal component.

In one embodiment, the displacement device 154 may comprise a motor, pulley or any other suitable rotational displacement mechanism that permits the auxiliary blade 104 to be rotated about the second end 150 of the support member(s) 144, 146 so as to alter the position of the auxiliary blade 104 relative to the primary rotor blade 102. Alternatively, the displacement device 154 may comprise a hydraulic or pneumatic cylinder, rack and pinion or any suitable linear displacement mechanism that permits the support member(s) 144, 146 and the auxiliary blade 104 to be displaced linearly in any direction (e.g., in the chordwise direction) and/or permits the height 142 of the passage 140 to be increased or decreased. It should be appreciated that, in embodiments in which the support member(s) 144, 146 may be rotated and/or linearly displaced, the primary rotor blade 102 may be configured to accommodate such movements. For example, as shown in FIG. 4, a slot or elongated opening 152 may be defined in the suction side 112 of the primary rotor blade 102 to allow the support member(s) 144, 146 to be moved relative to the primary rotor blade 102.

It should be appreciated that, when adjusting the position of the auxiliary blade 104, the support members 144, 146 may be configured to be rotated, displaced and/or or otherwise moved simultaneously or synchronization with one another. In addition or as an alternative thereto, the support members 144, 146 may be configured to be rotated, displaced and/or otherwise moved independently of one another.

Additionally, in further embodiments, the orientation or pitch of the auxiliary blade 104 with respect to the primary rotor blade 102 may be made adjustable by rotationally or pivotally connecting the first end 148 of the support member(s) 144, 146 to the auxiliary blade 104. For example, as shown in FIG. 5, a pivot point 156 may be defined at the attachment point of the auxiliary blade 104 to each support member 144, 146 so as to permit the auxiliary blade 104 to pivot about the support member(s) 144, 146. In one embodiment, the pivot point 156 may include, for example, a transverse shaft or rod coupled to a motor (not shown) to facilitate pivotal movement of the auxiliary blade 104 about the support members 144, 146. Alternatively, a gear mechanism (not shown) may be utilized to rotationally attach the first end 148 of the support member(s) 144, 146 to the auxiliary blade 104. Various other pivotal or rotational attachment mechanisms/methods that may be utilized to pivotally or rotationally connect the first end 148 of the support member(s) 144, 146 to the auxiliary blade 104 should be apparent to those of ordinary skill in the art.

It should be appreciated that, although the auxiliary blade 104 is described herein as being mounted and/or coupled to the primary rotor blade 102, the auxiliary blade 104 may, alternatively, be secured to any other suitable component of a wind turbine. For example, in another embodiment, the auxiliary blade 104 may be coupled to the hub 18 of the wind turbine 10 (FIG. 1) at its root end 130.

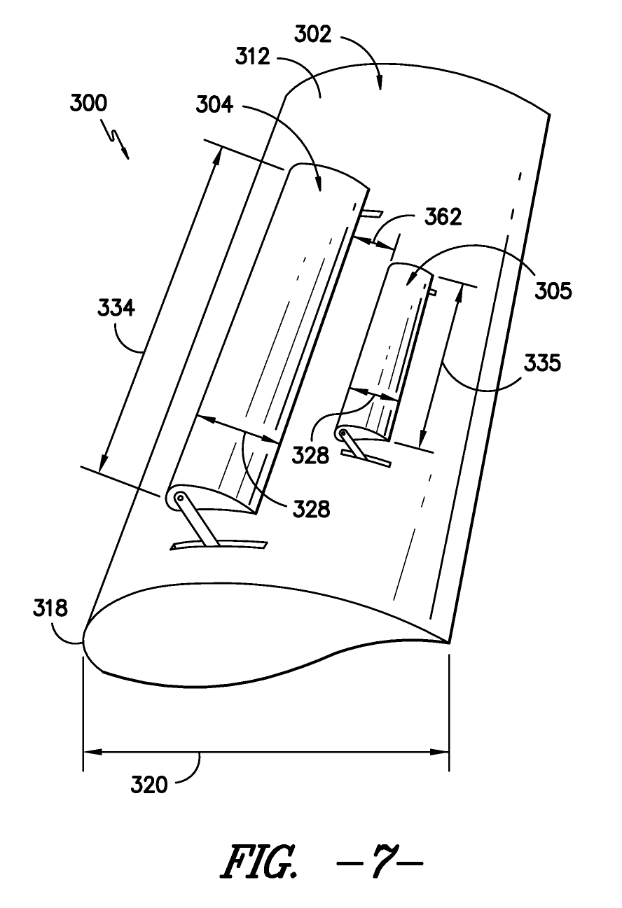

Referring now to FIG. 6, a partial perspective view of another embodiment of a rotor blade assembly 200 is illustrated in accordance with aspects of the present subject matter. As shown, the rotor blade assembly 200 includes a primary rotor blade 202 and an auxiliary blade 204 disposed on a suction side 212 of the primary rotor blade 202. In general, the primary rotor blade 202 and the auxiliary blade 204 may be configured as described above with reference to FIGS. 3-5. However, unlike the auxiliary blade 104 described above, the auxiliary blade 204 illustrated in FIG. 6 defines an auxiliary chord 228 (extending between the upstream edge 224 and the downstream edge 226) which varies in length along the auxiliary span 234. For example, as shown, the auxiliary chord 228 may decrease in length as auxiliary blade 204 extends in the spanwise direction from the root end 230 to the tip end 232. Alternatively, the auxiliary chord 228 may be designed to increase in length as the auxiliary blade 204 extends in the spanwise direction from the root end 230 to the tip end 232.

Moreover, as shown in the illustrated embodiment, the auxiliary blade 204 may be mounted or otherwise coupled to the primary rotor blade 202 such that the auxiliary blade is slanted or angled relative to the general spanwise direction of the primary rotor blade 202. Such an embodiment may be preferable when the optimum chordwise position for preventing or delaying flow separation varies at differing cross-sections along the span 118 (FIG. 3) of the primary rotor blade 202. For example, in one embodiment, the optimum chordwise position may be disposed at the maximum thickness 138 (FIG. 5) of the primary rotor blade 202 for any particular chord 220 along the span 118 of the primary rotor blade 202. Accordingly, the illustrated configuration may permit the chordwise position of the auxiliary blade 202 to be adjusted along the span 118 to track the location of maximum thickness 138 of the primary rotor blade 202.

As shown in FIG. 6, in one embodiment, the distance 260 between the upstream edge 224 of the auxiliary blade 204 and the leading edge 214 of the primary rotor blade 202 may increase as the auxiliary blade 204 extends in a spanwise direction from the root end 230 and the tip end 232. Alternatively, auxiliary blade 204 may be configured such that the distance 260 decreases as the auxiliary blade 204 extends in a spanwise direction from the root end 230 and the tip end 232. It should be appreciated that, although the auxiliary blade 204 is shown in FIG. 6 as having a substantially linear configuration such that the chordwise position of the auxiliary blade 204 changes at a constant rate between the root end 230 and the tip end 232, the auxiliary blade 204 need not have such a configuration. For example, the auxiliary blade 204 may be curved along its auxiliary span 234 to permit the distance between the upstream edge 224 of the auxiliary blade 204 and the leading edge 214 of the primary rotor blade 202 to be adjusted in a non-linear fashion. Alternatively, the auxiliary blade 204 may be twisted along its auxiliary span 234 to allow the chordwise position of the auxiliary blade 204 to be varied relative to the primary rotor blade 202.

Referring now to FIG. 7, there is illustrated yet another embodiment of a rotor blade assembly 300 for a wind turbine. As shown, the rotor blade assembly 300 includes a primary rotor blade 302 and a plurality of auxiliary blades, such as first and second auxiliary blades 304, 305, disposed on the suction side 312 of the primary rotor blade 302. In general, the primary rotor blade 302 and the auxiliary blades 304, 305 may be configured as described above with reference to FIGS. 3-6. Additionally, it should be appreciated that, although only two auxiliary blades 304, 305 are shown, the rotor blade assembly 300 may include any number of auxiliary blades disposed on the suction side 312 of the primary rotor blade 302.

As shown in FIG. 7, in one embodiment, each auxiliary blade 304, 305 may have differing dimensions. For example, the first auxiliary blade 304 may define a differing auxiliary chord 328 and span 334 than the auxiliary chord 329 and span 335 defined by the second auxiliary blade 305. Similarly, the auxiliary blades 304, 305 may define differing shapes. For instance, the first auxiliary blade 304 may define a substantially aerodynamic cross-section (e.g., a symmetric or cambered airfoil) while the second auxiliary blade 305 may define a substantially non-aerodynamic cross-section (e.g., a rectangular cross-section) and vice versa. Alternatively, the auxiliary blades 304, 305 may be configured to have the same or similar dimensions and/or shapes. Further, the auxiliary blades 304, 305 may be configured to have the same or differing pitches relative to the primary rotor blade 302 and/or the same or differing heights 142 of the passages 140 (FIG. 5) defined between the auxiliary blades 304, 305 and the primary rotor blade 302.

It should be appreciated that, when multiple auxiliary blades 304, 305 are included in the rotor blade assembly 300 of the present subject matter, the auxiliary blades 304, 305 may generally be disposed at any suitable location along the chord 320 of the primary rotor blade 302. However, in a particular embodiment of the present subject matter, it may be preferable for the auxiliary blade located furthest upstream on the primary rotor blade 302 (e.g., the first auxiliary blade 304) to be disposed at a location between the leading edge 318 of the primary rotor blade 302 and the separation point 36 (FIG. 2). In such an embodiment, any auxiliary blade(s) located downstream of the most upstream auxiliary blade (e.g., the second auxiliary blade 305) may be disposed at any suitable location(s) downstream of the separation point 36. Additionally, it should be appreciated that, in one embodiment, the auxiliary blades 304, 305 may generally be spaced apart from one another in a chordwise direction any suitable distance 362. However, in a particular embodiment of the present subject matter, the distance 362 may be equal to less than about 50% of the maximum chord of the primary rotor blade 302, such as from about 5% to about 40% of the maximum chord or from about 20% to about 30% of the maximum chord and all other subranges therebetween. Alternatively, the auxiliary blades 304, 305 may be spaced apart from one another in the spanwise direction. For example, in a particular embodiment, the auxiliary blades 304, 305 may be generally aligned in the chordwise direction and spaced apart from one another in the spanwise direction.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade assembly for a wind turbine, comprising:
a primary rotor blade, the primary rotor blade including a pressure side and a suction side extending between a leading edge and a trailing edge; and,
an auxiliary blade disposed on the suction side of the primary rotor blade, the auxiliary blade including an upstream edge and a downstream edge,
wherein the upstream edge of the auxiliary blade is positioned downstream of the leading edge of the primary rotor blade.

2. The rotor blade assembly of claim 1, wherein the auxiliary blade defines one of an aerodynamic cross-section and a non-aerodynamic cross-section.

3. The rotor blade assembly of claim 1, wherein the auxiliary blade is spaced apart from the primary rotor blade such that a passage is defined between the auxiliary blade and the suction side of the primary rotor blade.

4. The rotor blade assembly of claim 3, wherein the passage converges between the upstream edge and the downstream edge of the auxiliary blade.

5. The rotor blade assembly of claim 3, wherein the passage has an average height of about 0% to about 40% of the corresponding chord of the primary rotor blade at each spanwise location of the passage

6. The rotor blade assembly of claim 1, wherein the upstream edge of the auxiliary blade is positioned between the leading edge of the primary rotor blade and an airflow separation point of the primary rotor blade.

7. The rotor blade assembly of claim 1, wherein the auxiliary blade defines an auxiliary chord between the upstream edge and the downstream edge, the auxiliary chord being equal to about 0% to about 50% of the maximum chord of the primary rotor blade.

8. The rotor blade assembly of claim 1, wherein the auxiliary blade defines an auxiliary chord between the upstream edge and the downstream edge, the auxiliary chord varying as the auxiliary rotor blade extends in a generally spanwise direction along the primary rotor blade.

9. The rotor blade assembly of claim 1, wherein the auxiliary blade extends in a generally spanwise direction from generally adjacent a blade root of the primary rotor blade to a distance from the blade root equal to 0% to about 50% of the span of the primary rotor blade.

10. The rotor blade assembly of claim 1, wherein the auxiliary blade comprises a first auxiliary blade and a second auxiliary blade, the first and second auxiliary blades being spaced apart from one another along the suction side of the primary rotor blade.

11. The rotor blade assembly of claim 10, wherein the first and second auxiliary blades have at least one of differing pitches and differing heights of passages defined between each auxiliary blade and the primary rotor blade.

12. The rotor blade assembly of claim 1, wherein the auxiliary blade is configured such that a distance between the upstream edge of the auxiliary blade and the leading edge of the primary blade varies as the auxiliary blade extends in a generally spanwise direction relative to the primary blade.

13. The rotor blade assembly of claim 1, further comprising a first support member and a second support member, the first and second support members being configured to couple the auxiliary blade to the primary rotor blade.

14. The rotor blade assembly of claim 1, wherein at least one of the position and pitch of the auxiliary blade is adjustable relative to the primary rotor blade.

15. A rotor blade assembly for a wind turbine, comprising:
a primary rotor blade, the primary rotor blade including a pressure side and a suction side extending between a leading edge and a trailing edge;
an auxiliary blade disposed on the suction side of the primary rotor blade and including an upstream edge and a downstream edge, the auxiliary blade being configured such that a converging passage is defined between the auxiliary blade and the suction side of the primary rotor blade; and,
a support member, the support member being configured to couple the auxiliary blade to the primary rotor blade,
wherein the auxiliary blade is positioned between the leading edge of the primary rotor blade and an airflow separation point of the primary rotor blade.

16. The rotor blade assembly of claim 15, wherein the passage has an average height equal to about 0% to about 40% of the corresponding chord of the primary rotor blade at each spanwise location of the passage.

17. The rotor blade assembly of claim 15, wherein the auxiliary blade defines an auxiliary chord between the upstream edge and the downstream edge, the auxiliary chord being equal to about 0% to about 50% of the maximum chord of the primary rotor blade.

18. The rotor blade assembly of claim 15, wherein the auxiliary blade defines an auxiliary chord between the upstream edge and the downstream edge, the auxiliary chord varying as the auxiliary rotor blade extends in a generally spanwise direction along the primary rotor blade.

19. The rotor blade assembly of claim 15, wherein the auxiliary blade extends in a generally spanwise direction from generally adjacent a blade root of the primary rotor blade to a distance from the blade root equal to 0% to about 50% of the span of the primary rotor blade.

20. The rotor blade assembly of claim 15, wherein the auxiliary blade is configured such that a distance between the upstream edge of the auxiliary blade and the leading edge of the primary blade varies as the auxiliary blade extends in a generally spanwise direction relative to the primary blade.
